(19) United States
(12) Patent Application Publication
(10) Pub. No.: US 2003/0007634 A1
(43) Pub. Date: Jan. 9, 2003

(54) Hang device for a mobile phone

(76) Inventor: Huo-Sheng Wang, Taipei Hsien (TW)

Correspondence Address: Dougherty & Troxell, ONE SKYLINE PLACE, SUITE 1404, 5205 LEESBURG PIKE, FALLS CHURCH, VA, 22041, US

(21) Appl. No.: 09/923,450

(22) Filed: Aug. 8, 2001

(30) Foreign Application Priority Data
Jul. 5, 2001 (TW) 090211321

(51) Int. Cl. H04M 1/00

(52) U.S. Cl. 379/447

(57) ABSTRACT

A hang device for a mobile phone comprises a hanging base, a spool, an elastic clip, and an outer cover. The hanging base provides a spool chamber for receiving the spool and the spool chamber at a center thereof extending outward a hanging spindle. The hanging spindle at an end thereof is attached with a spring to urge a projection piece and the projection piece at an end thereof extends a projection stop. The hanging base at the back thereof provides a back groove, and a thread hole is disposed near the spool chamber. The pool provides two opposite flanges with a pulled thread wound around a center between the flanges. A torsional spring is mounted in the spool with an end thereof being fixedly attached to the hanging spindle. One of the flanges provides a flange ring against the projection stop. The elastic clip is made of a bent sheet material and has a facial side thereof be joined to the hanging base and the other one of the facial sides be joined to the outer cover. The outer cover is attached to the elastic clip and is possible to engage with an end of the hanging. The pulled thread connects with the mobile phone through the thread hole so that the pulled thread can be drawn. When a retaining ring on the mobile phone is inserted into the back groove and push the projection piece, the projection stop can be free from the flange ring such that torsional spring can rewind the pulled thread to inward to complete the retraction of the pulled thread.

### BACKGROUND OF THE INVENTION

1. Field of The Invention

The present invention relates to a hang device for a mobile phone, and particularly to hang device, which provides a pulled thread connected to a mobile phone to remind the owner to bring back the mobile phone thereof as soon as it is left behind.

2. Description of Related Art

Due to the development of business society, it is getting more that the articles are carried with us, and especially, the mobile phone has become popular in the recent years so that almost every one has a mobile phone. In order to keep control of the facility and the handiness for communicating with others, usually the mobile phone is carried with the user.

The way for the mobile phone being carried by the user completely depends on the brand and the model type of the mobile phone. The most common way being used for carrying the mobile phone is that the mobile phone is hung by the waist, that is, a hang tool is attached to the waist and the mobile phone engages with or hangs on the hang tool so that it is possible for the mobile phone to be taken out whenever it is needed and to be put back whenever it is not in use.

However, the mobile phone is often neglected to put back to the hang tool and left behind at somewhere due to the user focusing on a specific business so that it has resulted in inconvenience after the user acknowledged the mobile was missing. It is believed that the user more or less has experienced the forgotten mobile phone. Hence, how to avoid the incidence regarding the mobile phone being left behind is a subject worth us to care about.

### SUMMARY OF THE INVENTION

An object of the present invention is to provide a hang device for a mobile phone, which comprises a hanging base, a spool, an elastic clip, and an outer cover and the mobile phone can be connected to a pulled thread wound on the spool and the pulled thread is possible to remind the user to bring back the mobile phone as soon as the mobile is left behind.

### BRIEF DESCRIPTION OF THE DRAWINGS

The present invention can be more fully understood by referencing to the following detailed description and accompanying drawings, in which:

FIG. 1 is an exploded perspective view of a hang device for a mobile phone according to the present invention;

FIG. 2 is a perspective view of the hang device shown in FIG. 1 after being assembled;

FIG. 3 is a cross section of a hanging base and a spool in the hang device according to the present invention; and

FIG. 4 is a fragmentary sectional view of the spool being in a state of taking the thread in.

### DETAILED DESCRIPTION OF THE PREFERRED EMBODIMENTS

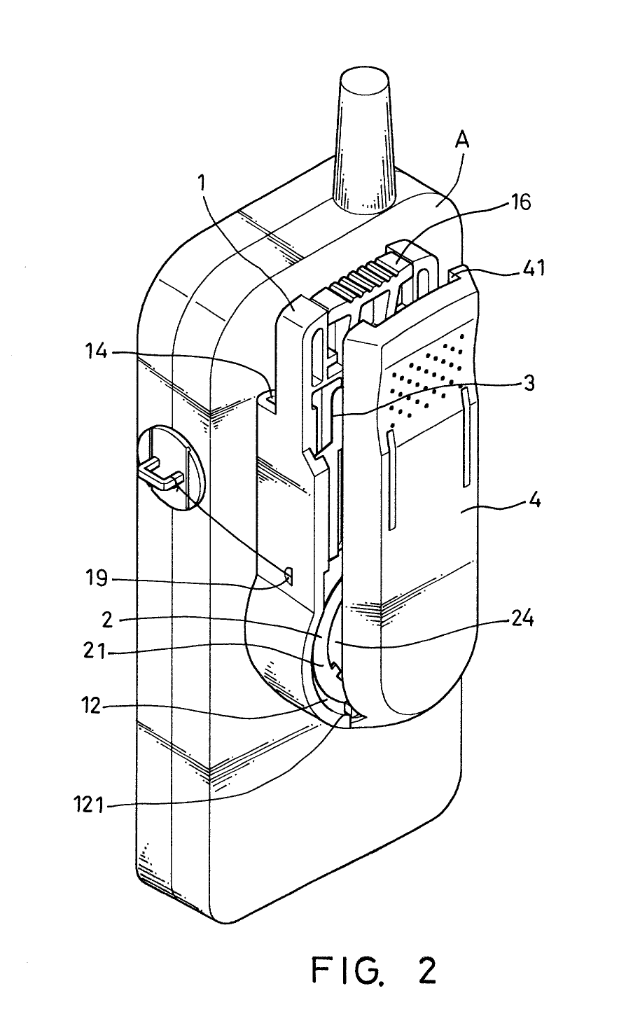

Referring to FIG. 2, a hang device for a mobile phone according to the present invention basically comprises a hanging base 1, a spool 2, and an elastic clip 3.

Wherein, the hanging base 1 at an end thereof has a hanging spindle 11 for locating the spool 2. The hanging spindle 11 surrounded by an outer wall so that a spool chamber 12 is formed between the hanging spindle 11 and the outer wall. The outer wall at the periphery thereof provides a recess 121 so that the spool 2 can be received in the spool chamber 12. A spring chamber 13 extends upward from the rear end of the hanging spindle 11 and a spring 131 is received in the spring chamber 13. The spring 131 further fits with an end of a projection piece 132 and the projection piece 132 at another end thereof reaches to a back groove 14. The projection piece 132 at a lateral side thereof has a projection part 1321 such that a recess is formed at the upper portion thereof. The projection part 1321 can be pressed against the back inner wall surface of the hanging base 1, and further the back inner wall surface has a jut stopper 133 against the recess on the projection piece 132. Thus, the projection piece 132 can squeeze the spring 131 during being exerted by a force and the jut stopper 133 resists the projection piece 132 to bounce outward. The projection piece 132 at another lateral side thereof has a projection stop 1322 for controlling the spool 2.

The hanging base 1 at the center thereof provides two parallel hanging ribs 15 to confine a push key 16. The push key 16 provides two parallel push ribs 161 with a front slant end 1611 respectively. The push key 16 at the middle part thereof has a rib chamber 162 with a spring 163 and a cross frame 164 with a tilt back is disposed next to the front end of the spring 163 and is received in a frame recess 1641 with a backward protrusion. The cross frame 164 at both lateral sides thereof has a side wing 1642 respectively and the both side wings 1642 are restricted by the front slant end 1611 of the respective push rib 161. Thus, when the push key 16 is pushed and the respective front slant end 1611 raises the respective side wing 1642, the push frame 164 may retreat inward such that the mobile phone can be free from the state of being caught and can be taken out. The push rib 161 can be restored to the original position thereof by way of the rebound of the spring 163 as soon as the force is exerted to push the push key 16 is released, and the slant end 1611 retreats to urge the push frame 164 such that the push frame 164 can project outward the rear side of the hanging base 1 again.

In order to locate the elastic clip 3, the hanging base at both lateral walls 17 thereof provides a locating groove 171 respectively to be attached by the elastic clip 3. In the meantime, the push frame 164 provides a frame projection 1643, and the hanging base 1 extends a base jut 18 at the back of the spring 163. In addition, the hanging base 1 at the outer wall thereof has a thread hole 19 next to the spool chamber 12 to be passed through by a pulled thread 22.

The spool 2 has a shape of disk and at two lateral sides thereof provides a flange 21 respectively opposite to each other so that the thread can be wound in a space between the flanges 21. Besides, a torsional spring 23 is mounted at the central part of the spool 2 and a side shield plate 24 covers the lateral side of the spool 2. The center of the shield plate 24 engages with a bushing 25 and an end of the torsional spring 23 is fixed to the hanging spindle 11. Hence, the pulled thread 22 can be rewound after being pulled outward, and this is belonged to the prior art so that no detail will be described further. One of the flange 21 faces the rear side of the hanging base 1 has an inner recess such that a flange ring 211 is constitutes and the inner circumference thereof is caught by the projection stop 1322 after assembling.

The elastic clip 3, which is made of elastic sheet material, provides a clip hole 31 to correspond to the frame projection 1643 and the base jut 18 respectively such that it is possible for the elastic clip 3 to be fixedly attached to the base 1. The elastic clip 3 at another side thereof has a cover hole 32 near an end thereof to engage with a cover tenon 42 on an outer cover 4 during assembling.

The outer cover 4 provides a size thereof corresponding to the hanging base 1 and a cover groove 41 at both lateral walls thereof respectively to be inserted with the spring clip 3. The cover tenon 42 extends from the outer cover 4 corresponding to the cover hole 32 so that it is possible for the cover tenon 42 to engage with the outer cover 4 for a further engagement between the elastic clip 3 and the outer cover 4 as soon as the elastic clip 3 inserts into the respective cover groove 41.

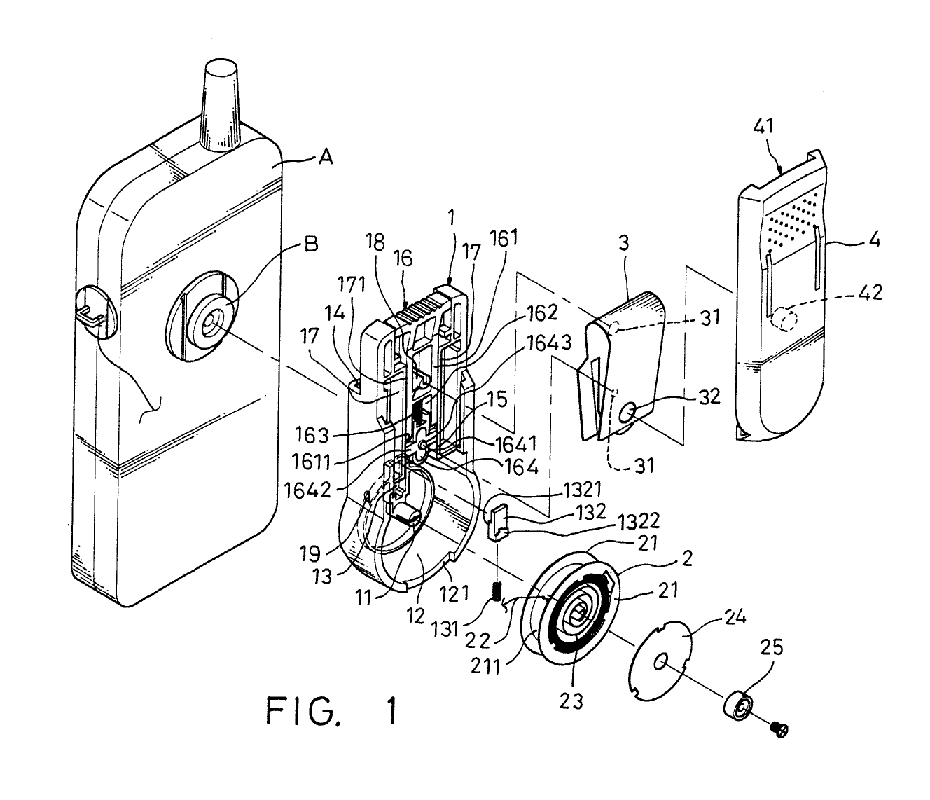

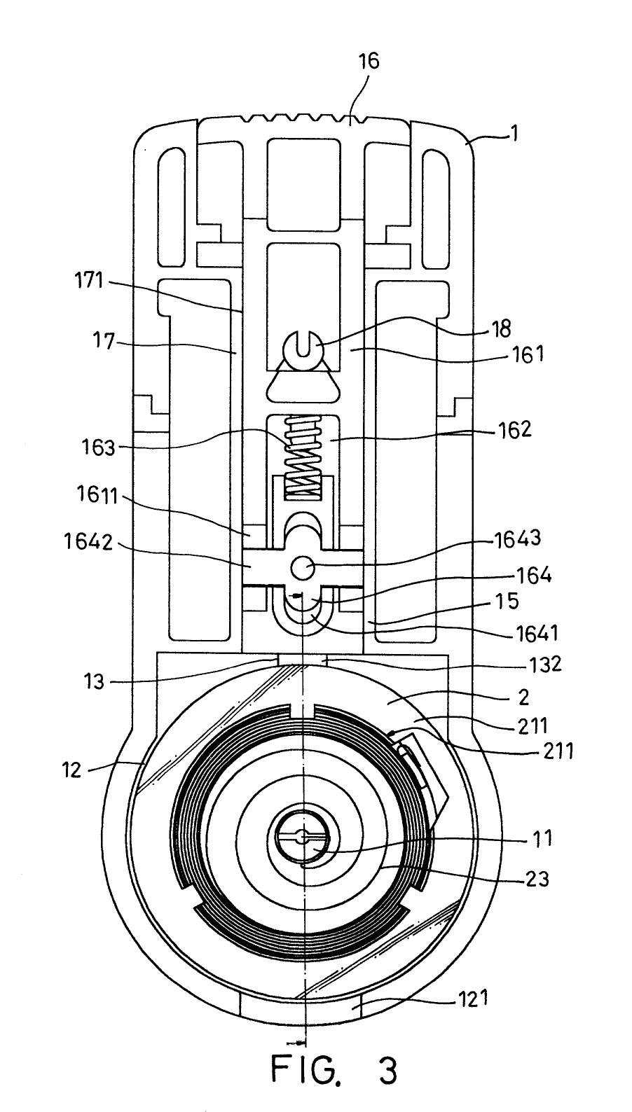

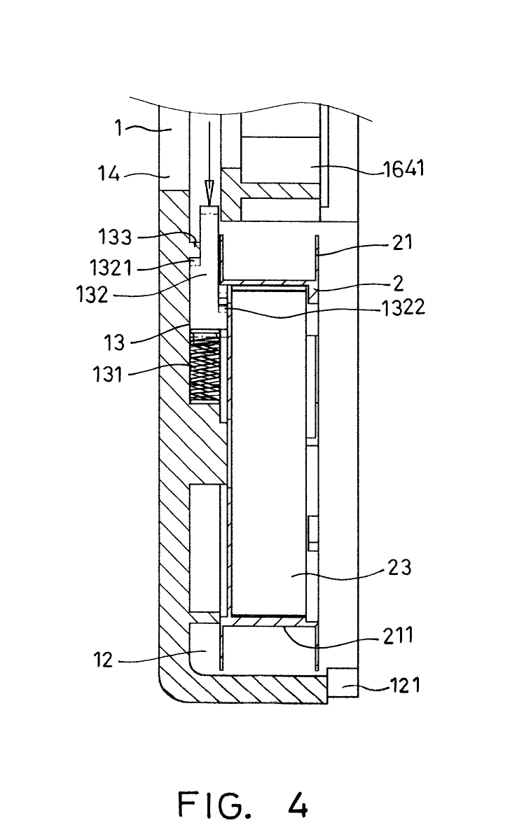

Referring to FIGS. 1 to 4 again, the appearance of the hang device for a mobile phone according to the present invention is shown in FIG. 2. An end of the pulled thread is connected to the spool 2 and the other end thereof is connected to the mobile phone A, and the mobile phone A can be attached to the hang device by way of a retaining ring B on the mobile phone A engaging with the back groove 14 in the hanging base 1. Once the outer cover 4 and the hanging base 1 at their upper parts thereof are pressed, the lower end of the hanging base 1 can expand outward, and the hanging base 1 can engage with the mobile phone A again by way of the elastic clip 3 as soon as the pressing force is released from the hanging base 1 and the outer cover 4. Thus, the mobile A can be hung on the leather belt of a user or the like.

Referring to FIGS. 1 to 4 further, when the mobile phone A is to be engaged to the hang device, the retaining ring B is vertically inserted into the hanging base 1 through the back groove 14 and is turned to a right position, the retaining ring B then can be located at the cross frame 164 without being slipped out.

When the mobile phone A is going to be used, the push key 16 is pressed to move the slant end 1611 upward against the side wings 1642 so that the cross frame 164 may retreat and disengage the retaining ring B and the mobile phone A can be taken out from the hang device. Right at this time, the pulled thread 22 can be pulled outward along with the mobile phone A, and the projection piece 132 is urged by the spring 131 to press the projection stop 1322 against the inner circumference of the flange ring 211 on the flange 21 facing the rear side of the hanging base so that the pulled thread 22 can be pulled out to any distance with the mobile phone and stays there as soon as the pulling force is ceased.

In case of the mobile phone A being left behind at any place, the pulled thread 22 can remind the user to bring back the mobile phone A as soon as the user trails along with the mobile phone A. The retaining ring B on the mobile phone A then can be inserted into the back groove 14 in the hanging base 1 horizontally to the end of the back groove 14 to pass over the slant cross frame 164. Thus, the periphery of the retaining ring 14 pushes the projection piece 132 and the inner circumference of the flange ring 211 of the flange 21 on the spool 22 is free from being caught by the projection stop 1322 such that the torsional spring 23 can rewind the pulled thread 22 inward to complete the retraction of the pulled thread.

It is appreciated that the hang device for a mobile phone according to the present invention can remind the user to bring back the mobile phone by way of a pulled thread in case of the mobile phone being left behind so that the problem of missing the mobile phone can be solved completely. Therefore, the present invention is a breakthrough for the use of a mobile phone.

While the invention has been described with reference to a preferred embodiment thereof, it is to be understood that modifications or variations may be easily made without departing from the spirit of this invention, which is defined by the appended claims.

What is claimed is:

1. A hang device for a mobile phone, comprising:
a hanging base, providing a spool chamber, the spool chamber at a center thereof extending outward a hanging spindle, the hanging spindle at an end thereof being attached with a first spring to urge a projection piece, the projection piece at an end thereof extending a projection stop, the hanging base at a back thereof providing a back groove, and an aperture being disposed near the spool chamber;
a spool, being received in the spool chamber, providing two opposite flanges with a pulled thread wound around a center in between, a second spring being mounted therein with an end thereof being fixedly attached to the hanging spindle, one of the flanges providing a flange ring against the projection stop;
an elastic clip with two facial sides, being formed by way of bent sheet material, one of the facial sides being joined to the hanging base and the other one of the facial sides being joined to the outer cover; and
an outer cover, being attached to the elastic clip, and being possible to engage with an end of the hanging;
whereby, the pulled thread connects with mobile phone through the thread hole so that the pulled thread can be drawn; when a retaining ring on the mobile phone can be inserted into the back groove and push the projection piece, the projection stop can be free from the flange ring such that the second spring can rewind the pulled thread inward to complete the retraction of the pulled thread.

2. The hang device for a mobile phone according to claim 1, wherein the hanging base at two opposite lateral walls thereof has a wall groove respectively so that the one facial side of the elastic clip can be inserted into the wall grooves and the outer cover has a cover groove so that the other one facial side can be inserted into the cover groove.

3. The hang device for a mobile phone according to claim 1, wherein the hanging base may provides a press device and the press device has two hanging ribs to confine a push key; the push key has two parallel push ribs with a front slant end respectively and at the middle portion thereof has a rib chamber with a spring therein; a frame recess is disposed in front of the spring to contain a cross frame and the cross frame can be urged by the respective front slant end 611 to move upward so as to release from being caught in the back groove.

4. The hang device for a mobile phone according to claim 1, wherein the second spring in the spool can be covered by way of a side shield plate.
